(19) United States
(12) Patent Application Publication
(10) Pub. No.: US 2015/0187037 A1
(43) Pub. Date: Jul. 2, 2015

(54) DYNAMIC PATIENT ENGAGEMENT

(71) Applicant: Zynx Health Incorporated, Los Angeles, CA (US)

(72) Inventors: Siva Subramanian, Sunnyvale, CA (US); Sathi Tadi, Fremont, CA (US); Sharon M. Young, Santa Monica, CA (US); Eric Stoltz, Los Angeles, CA (US); Bernadette Minton, Los Angeles, CA (US)

(21) Appl. No.: 14/583,032

(22) Filed: Dec. 24, 2014

Related U.S. Application Data
(60) Provisional application No. 61/922,753, filed on Dec. 31, 2013.
(60) Provisional application No. 61/943,079, filed on Feb. 21, 2014.

(51) Int. Cl. G06Q 50/22; G06Q 10/10

(52) U.S. Cl. CPC G06Q 50/22; G06Q 10/10

(57) ABSTRACT

Methods and systems are provided for providers on a health care team to engage with a patient before, during and after an acute care event. The methods include providing an interactive checklist of action items to the patient to be completed by the user before, during or after the acute care event and providing an interface for communication and notification among the plurality of providers and the patient about one or more of the action items on the interactive checklist.

### CROSS REFERENCE TO RELATED APPLICATIONS

This application claims priority under 35 U.S.C. §119(e) to U.S. Provisional Patent Application Ser. No. 61/922,753, “Dynamic Patient Engagement,” filed Dec. 31, 2013, and to U.S. Provisional Application Ser. No. 61/943,079, “Dynamic Patient Engagement,” filed on Feb. 21, 2014. Both of these provisional applications are incorporated herein by reference in their entireties.

### BACKGROUND

This invention relates generally to methods and systems for dynamically engaging patients and health care providers in the health care process.

Conventional methods and systems are limited in ways to provide patients with direct and effective communication with health care providers before, during, and after an acute care event. It can be difficult for health care providers to gather current and timely information about the patient's condition prior to and after an acute care event. For example, a patient may be required to partake in particular activities or tasks to prepare for a health care event, such as surgery. In addition, the patient's condition may need to be monitored after the acute care event, and the patient may need to complete a variety of tasks as part of his or her post-acute care event treatment, such as taking a medication or following a particular diet or health care regimen. Communicating in a timely manner among members of a health care team and a patient before, during, and after an acute care event can be challenging given current modes of communication used in health care settings.

Thus, current health care methods and systems fail to provide effective and timely means for a patient to communicate necessary information about his or her condition and health related activities to providers throughout the patient care process.

### SUMMARY

The invention provides a computer-implemented method for engaging with a patient including steps for accessing a plurality of rules configured for patient care before, during, and after an acute care event, connecting a patient undergoing the acute care event to a plurality of providers on a health care team via a mobile application on a user device, providing a user interface to the patient comprising an interactive checklist of action items for the patient to perform at a plurality of time points and information about the acute care event, wherein the time points occur before or after the acute care event, wherein the information about the acute care event comprises a location, members of the health care team, and a schedule of the acute care event. The method also includes providing an interface for communication among members of the health care team and for communication with the patient about the acute care event and the checklist of action items for the patient, receiving an indication from the patient about whether the patient has completed one or more action items on the checklist, and sending a notification to the members of the health care team about the one or more actions items that have been completed or are pending on the checklist.

In one embodiment, the method includes configuring a plurality of rules for patient care before, during or after an acute care event. In another embodiment, responsive to receiving the indication from the patient, the method includes modifying one or more of the action items on the interactive checklist. In one embodiment, responsive to receiving the indication from the patient, the method comprises modifying one or more of the rules associated with the acute care event.

In another embodiment, the method includes receiving instructions from one or more members of the health care team to modify the action items on the checklist. In another embodiment, the method includes receiving instructions from one or more members of the health care team to modify the rules associated with the acute care event. In one embodiment, the method comprises sending a notification to the patient to complete one or more action items before or after an acute care event. In yet another embodiment, the method comprises providing a revised checklist of action items to the patient.

In some embodiments, the members on the health care team are determined based on roles required before, during and after the acute care event care of the patient. In another embodiment, the interactive checklist of action items comprises action items associated with the patient's health. In yet another embodiment, the interactive checklist of action items comprises inputs about the condition of the patient.

The invention includes a computer-implemented method for engaging with a patient by accessing a plurality of rules configured for patient preparation and care prior to an acute care event, connecting a patient preparing to undergo the acute care event to a plurality of providers on a health care team via a mobile application on a user device, and providing an interactive checklist of action items to the patient based on the plurality of rules, the action items to be completed by the user prior to the acute care event. The method also includes receiving an indication from the user device about whether the patient has performed one or more of the action items on the interactive checklist prior to the acute care event, and sending a notification to the plurality of providers about the indication from the patient device about whether the patient has performed one or more of the action items on the interactive checklist prior to the acute care event. In some embodiments, responsive to receiving an indication from the patient that an action item has not been completed, the method includes sending a notification to the patient to complete the action item and providing an interface for the plurality of providers to communicate with the patient about the one or more action items to be completed.

Another embodiment includes a computer-implemented method for engaging with a patient by accessing a plurality of rules configured for patient preparation and care after an acute care event, connecting a patient undergoing the acute care event to a plurality of providers on a health care team via a mobile application on a user device, providing an interactive checklist of action items to the patient based on the plurality of rules, the action items to be completed by the user after the acute care event, receiving an indication from the user device about whether the patient has performed one or more of the action items on the interactive checklist after the acute care event, and sending a notification to the plurality of providers about the indication from the patient device about whether the patient has performed one or more of the action items on the interactive checklist after the acute care event. The method also includes responsive to receiving an indication from the patient that an action item has not been completed, sending a notification to the patient to complete the action item, and providing an interface for the plurality of providers to communicate with the patient about the one or more action items to be completed.

### BRIEF DESCRIPTION OF THE DRAWINGS

FIG. 1 is a high-level block diagram that illustrates a system environment 100 for team-based health care management, according to an embodiment of the invention.

FIG. 2 is a high-level block diagram illustrating an example of a computer, according to one embodiment of the invention.

FIG. 3 illustrates an example of a plurality of health care providers who are connected to a patient as part of a health care team, according to an embodiment of the invention.

FIG. 4 illustrates an example timeline for a patient based on an acute care event, showing the different health care teams assigned to the patient before, during and after an acute care event, according to an embodiment of the invention.

FIG. 5 illustrates an example of a screenshot of a checklist application and messaging module on a mobile device, according to one embodiment of the invention.

FIG. 6 illustrates a timeline for an acute care event and communications among the patient and providers on the health care team, according to one embodiment of the invention.

FIG. 7 illustrates a user interface on a mobile device for viewing tasks and activities related to a patient's daily treatment or care, according to one embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

The invention provides methods and systems for providers on a health care team to dynamically engage and communicate with a patient prior to, during, and after an acute care event via a mobile communication platform.

An acute care event includes, but is not limited to, a health care event, process, treatment, intervention, regimen, medical visit or assessment, examination, or procedure for a patient. Some examples include, but are not limited to, a physician or hospital visit, surgical procedure (invasive or non-invasive), health exam, routine or follow up visit, blood test, urine test, gastro-intestinal (GI) testing, immunization, health screening, cosmetic procedure, or other health related procedures (e.g., x-ray, magnetic resonance imaging (MRI)).

A health care provider can be a physician, specialist (e.g., anesthesiologist, cardiologist, gastroenterologist, obstetrician, surgeon), social worker, physical therapist, hospital administrator, case manager, charge nurse, home care nurse, nurse's assistant, dietician, physician's assistant, or other health care worker. In some embodiments, the health care provider can be associated with or affiliated with one or more hospitals, health care groups or organizations, or a health care facility. The health care provider also includes members of the patient's immediate family, friends, or caregivers. The various health care providers who are assigned or associated with the patient form a health care team for the patient and act as members of the health care team.

The members of the health care team can be associated with one or more health care facilities or organizations, and these can include facilities or organizations that are not affiliated with one another or owned by the same entity.

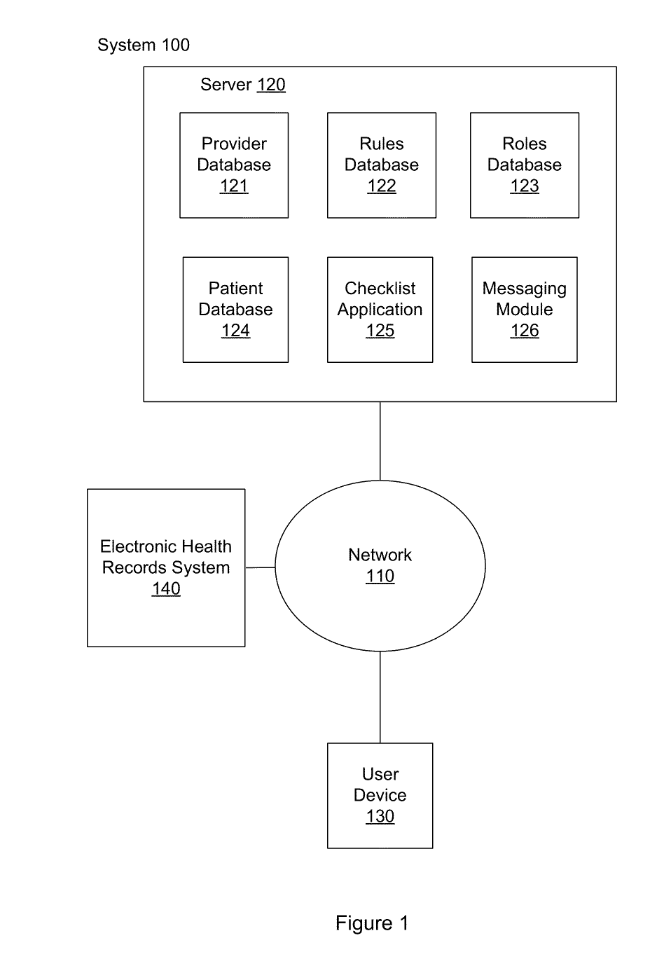

FIG. 1 is a high-level block diagram that illustrates a system environment 100 for team-based health care management. As shown, the system environment 100 includes a network 110, a server 120, a user device 130, and an electronic health records (EHR) system 140.

The network 110 represents the communication pathway between the server 120 and the user device 130. In one embodiment, the network 110 uses standard communications technologies and/or protocols and can include the Internet as well as mobile telephone networks. Thus, the network 110 can include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 110 can be represented using technologies and/or formats including image data in binary form (e.g. Portable Network Graphics (PNG)), the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities on the network 110 can use custom and/or dedicated data communications technologies instead of, or in addition to, the ones described above.

The server 120 includes a provider database 121, a rules database 122, a roles database 123, a patient database 124, a checklist application 125, and a messaging module 126. Other databases and modules can be included instead of, or in addition to, those described herein.

The provider database 121 stores data about the health care providers who form health care teams assigned to patients. The provider database 121 can include data for physicians, specialists, interns, hospital administrators, nurses, physician's assistants, counselors, social workers, other health care specialists and the like. The data stored for a health care provider can include his or her experience, background, skills, credentials, and/or affiliation with organizations, hospitals and other health care settings. Examples of health care settings include, but are not limited to, academic or research hospitals, medical offices, medical institutions, outpatient facilities, home-care settings, or clinics. Data about the health care provider can also include his or her work shift, availability of hours, ability to perform certain tasks, previous history with a patient, and roles or positions within the health care setting. As used herein, a provider can refer to any health care provider on a health care team, and can be used interchangeably with the term “member” or “team member.”

The rules database 122 stores rules for determining action items for a patient's treatment and care in association with an acute care event. These rules can be configured for use in the system prior to engagement with a patient, and can be referred to herein as predetermined rules. The rules can be generated from medical guidelines, recommendations, standards, input from health care providers, or other conventional medical practices for determining action items for a patient before, during, or after an acute care event. The rules are used to determine the number and type of action items that a patient must perform in preparation for, during, and after an acute care event. Examples of action items can include, but not limited to, following a diet regimen, following an exercise program, taking medications in a timely manner, monitoring blood sugar or blood pressure, getting an x-ray, measuring body temperature, reporting physical symptoms, such as one's ability to walk, or reporting pain measures. The rules are stored and can be used to associate or match the patient's symptoms, disorder, disease, and/or other medical condition(s) with checklist action items for the patient prior to or after the acute care event. The rules can also determine which health care roles are required for a health care team assigned to the patient for the acute care event (e.g., surgery requires one surgeon, one anesthesiologist, one nurse, etc.).

The roles database 123 stores various roles that are filled by health care providers on a health care team. Examples of roles include, but are not limited to, a physician (including various types of physicians and specialists), medical intern, nurse (various types of nurses, e.g., charge nurse, surgery nurse, home care nurse), physician's assistant, hospital administrator, lab technician, or hospital worker. Each role can be stored with required experience, skills, credentials, training, areas of expertise, background, and/or abilities to perform certain tasks. For each patient condition or situation, a different set of roles are required to form a health care team. The roles database 123 can store the types and number of roles needed for various medical conditions or needs for patients. These roles are used to assign individual providers to a health care team for a patient. Communication via a messaging system between the patient and the providers can also be based on the roles of the health care team. For instance, the individuals who perform the role of “charge nurse” may change over the course of treatment of a patient, but the role of “charge nurse” can remain as a part of the health care team assigned to the patient, and the individual assigned to the role at a given time can communicate with the patient based on the role.

The patient database 124 stores information about patients and can include information about the patient's medical condition, records, medical history, and other relevant information for the health care providers on the health care team. The health care providers can submit and store information about the patient in the patient database 124, and this patient information can be accessed by current and future team members as transition events occur for the patient and new teams are formed. This information can also be sent in notifications to the team of health care providers when needed. The patient data can be used to generate the interactive checklist of action items for the patient. For example, patient data about a patient's history of diabetes and high blood pressure can be used to generate a checklist of action items for a diabetes-based diet and exercise program for the patient in preparation for or after an acute care event.

In some embodiments, the server 120 includes a team formation engine (not shown), which is used to generate a health care team for the patient. Methods describing team formation are described in U.S. Ser. No. 13/966,265, filed on Aug. 13, 2013. The team formation engine can receive information about the patient's medical condition or need(s), which can include the patient's medical history, present medical condition, and/or need for treatment or preventative care. The team formation engine uses the rules database 122 to match the medical need(s) of the patient to roles for a health care team. The team formation engine can match the selected roles to available health care providers who meet the criteria for the roles. The team formation engine can notify the selected providers about filling the roles of the team via the messaging module 126. The team formation engine can also generate new health care teams and transition information between members of the previous health care team to a new health care team for the patient. The team formation engine can introduce a new role to a team by adding a new health care provider, or replace a first provider in a role with a second provider. Any changes to a previous team can constitute the formation of a new health care team for the patient.

The checklist application 125 uses the providers from the provider database 121, the rules from the rules database 122, and the roles from the roles database 123 to generate a checklist of action items for a patient to perform before, during and/or after an acute care event and to connect the patient to members of the health care team. The checklist application 125 can generate a checklist of action items for the patient based on the medical need/condition of the patient, an upcoming or past acute care event, predetermined rules about the required actions for treatment and care of the patient, and/or input from providers on the health care team, for example. The checklist application 125 generates the checklist of action items and presents them to the patient via a user interface on the mobile application. The patient can view and interact with the checklist by checking off items or clicking on items that have been completed. In some embodiments, the action of checking off an item will automatically send a notification to the members of the health care team that the patient has completed an action item. In other embodiments, the checklist application 125 can generate reminders to the user and/or members of health care team about pending items (not yet completed) on the checklist. In another embodiment, the checklist application 125 can generate notifications to the members of the health care team when a patient has completed an action item, or when a patient has not yet completed an action item. These notifications can be triggered by a notification date or a completion date set up for an action item. In some embodiments, the checklist application 125 can include a checklist of the pre- and/or post-acute care event tasks or items that the patient must report or complete prior to and/or after the acute care event. In other embodiments, the one or more health care providers on the health care team can provide input for generating the checklist of “to-do” items for the patient. In yet other embodiments, the checklist is generated automatically based on predetermined rules for treatment and/or care of the particular condition of the patient. These rules can be generated from health care studies, well-established health care practices, medical and research publications, etc.

In certain embodiments, the checklist application 125 can be an interactive tool that is coupled to the messaging module 126. In some embodiments, a patient's input about completion of a task on the checklist is communicated automatically to members of the patient's health care team. These notifications can be sent via text message, email, or other form of online, phone, or mobile communication. In other embodiments, the patient can manually send a communication to the health care team members about completion of an item on the checklist.

The messaging module 126 provides a communication interface for the providers and the patient to engage and communicate with each other. The messaging module 126 provides real-time communications among the patient and all members of the health care team based on the roles. For example, a patient may communicate information regarding her goals, priorities, concerns, and questions to her healthcare team or to a particular member of the healthcare team (e.g., a designated representative, such as a case manager) via the messaging module 126. The messaging module 126 allows each member on the health care team to see the various roles on the team and who is playing each role on the team. Information about the patient and notifications about the completed and pending checklist action items are sent to members of the health care team. A patient can also directly notify one or more members of the health care team based on the role of the health care team member. This can be a communication about the patient's symptoms, notifications about checklist action items, questions about treatment, preparation or post-recovery care, etc. One or more members of the health care team can respond to the patient via the messaging module 126. The health care team members can also use the messaging module 126 to communicate with the system to modify the checklist action items, reconfigure rules used to generate checklists, or modify or cancel the acute care event.

In one embodiment, the messaging module 126 transmits communications, such as questions or concerns, from the patient to a designated member on the patient's healthcare team. Specifically, when the patient initiates a communication with her healthcare team, the messaging module 126 accesses the patient database 124 and the roles database 123 to identify the member on the patient's healthcare team who is designated to triage the patient's communication. For example, the case manager may be designated as healthcare team member who will triage the patient's communication. Once the designated member is identified, the messaging module 126 transmits a notification to the designated member indicating the communication from the patient. The messaging module 126 enables the designated member to respond directly with the patient regarding the patient's communicated via the messaging module 126. Alternatively, the messaging module 126 enables the designated member to redirect the patient's communication to another member of the healthcare team who would be equipped to respond to the patient's communication. The other member can then respond directly to the patient's communication via the messaging module 126.

In one embodiment, a mobile application executing on the patient's device exposes interfaces to the messaging module 126 from various sections of the mobile application. For example, the mobile application may have a medication instructions section that exposes an interface to the messaging module 126. Such an interface allows the patient to communicate with her healthcare team from the section in the mobile application where the patient is viewing information about which she may have questions or concerns. Further, such an interface may allow the patient to provide additional context in her communications to the healthcare team. For example, the interface may allow the patient to highlight a portion of the section about which she has questions or concerns. The highlighted portion, or a representation thereof, may then be transmitted via the messaging module 126 to the healthcare team in conjunction with the patient's question or concern.

The user device (or devices) 130 can be any device that allows communication to the server 120 via the network 110. The user device 130 provides an interface with which a patient and one or more providers can interact with each other and the server 120 to view and engage in providing data, messages and notifications. Examples of user devices 130 include, but are not limited to, computers, smart phones, mobile phones, tablets, and the like.

The EHR system 140 maintains digital health records for at least a subset of the patients whose information is also stored in the patient database 124. In one embodiment, the server 120 interfaces with the EHR system 140 to retrieve relevant information about a patient and store that information in the patient database 124. Examples of such information include discharge instructions, emergency contact information, do-not-resuscitate instructions, and power of attorney documents. Retrieving information about a patient that is already available within the EHR system 140 reduces the amount of information that the patient's healthcare team needs to manually enter in order to populate the patient database 124. In some embodiments, information from the patient database 124 may be transmitted to the EHR system 140. For example, a change in the emergency contact information of a patient captured by the patient database 124 may be propagated to the EHR system 140 such that the EHR system 140 remains up-to-date.

Computer Overview

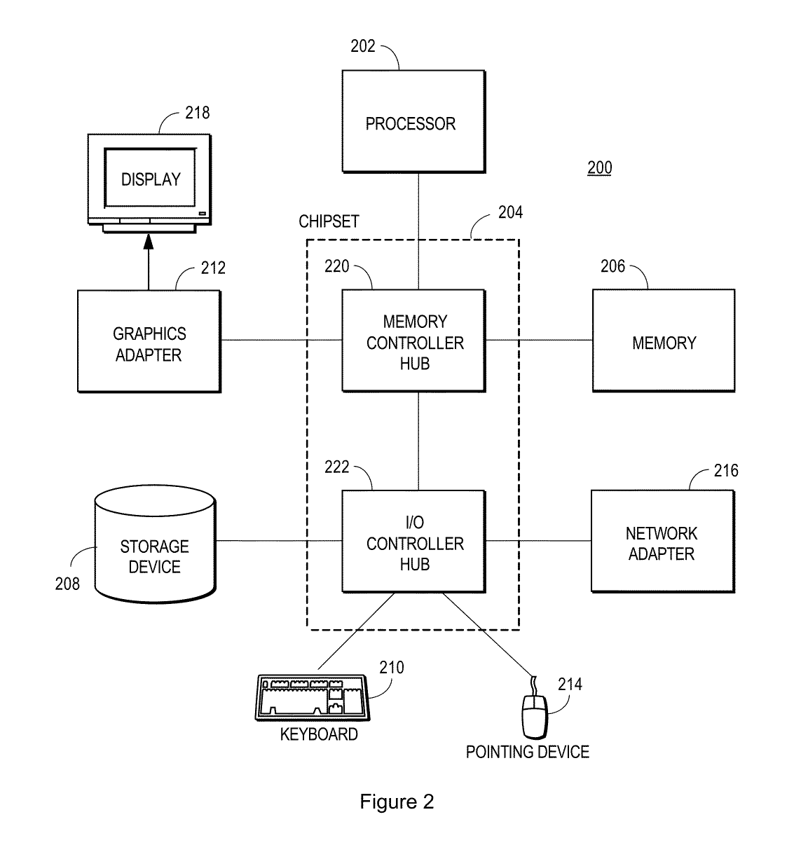

FIG. 2 is a high-level block diagram illustrating an example of a computer 200 for use as a server 120 or a user device 130, in accordance with one embodiment. Illustrated are at least one processor 202 coupled to a chipset 204. The chipset 204 includes a memory controller hub 250 and an input/output (I/O) controller hub 255. A memory 206 and a graphics adapter 213 are coupled to the memory controller hub 250, and a display device 218 is coupled to the graphics adapter 213. A storage device 208, keyboard 210, pointing device 214, and network adapter 216 are coupled to the I/O controller hub 255. Other embodiments of the computer 200 have different architectures. For example, the memory 206 is directly coupled to the processor 202 in some embodiments.

The storage device 208 is a non-transitory computer-readable storage medium such as a hard drive, compact disk read-only memory (CD-ROM), DVD, or a solid-state memory device. The memory 206 holds instructions and data used by the processor 202. The pointing device 214 is used in combination with the keyboard 210 to input data into the computer system 200. The graphics adapter 213 displays images and other information on the display device 218. In some embodiments, the display device 218 includes a touch screen capability for receiving user input and selections. The network adapter 216 couples the computer system 200 to the network 101. Some embodiments of the computer 200 have different and/or other components than those shown in FIG. 2. For example, the server 120 can be formed of multiple blade servers and lack a display device, keyboard, and other components.

The computer 200 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202.

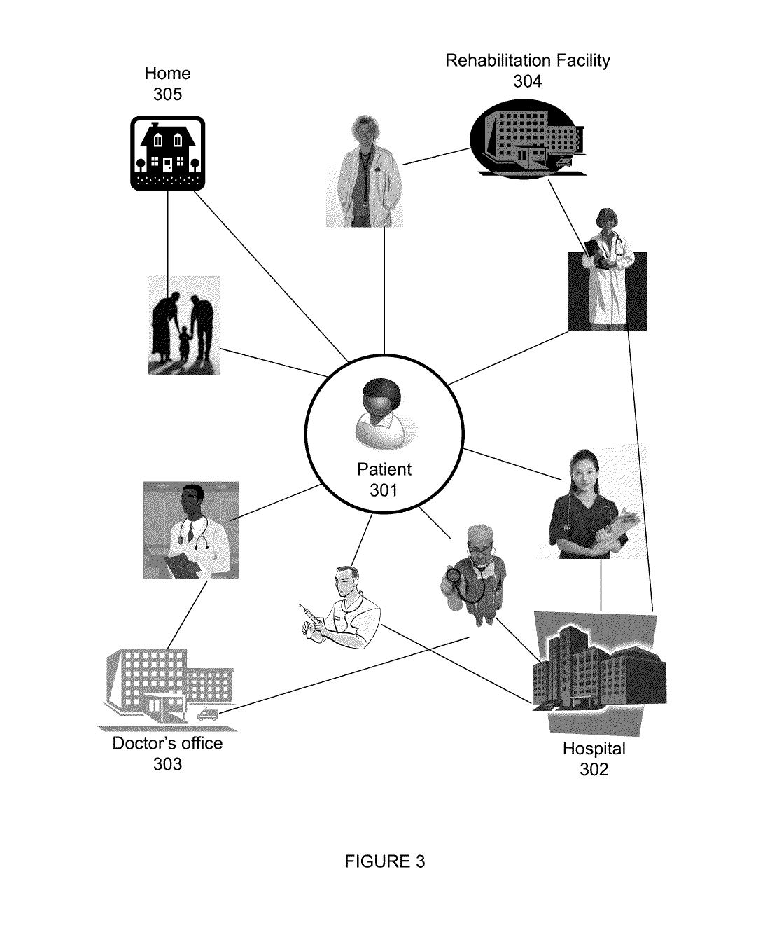

FIG. 3 provides an example of a network of various health care providers on a health care team who are connected to a patient 301. Each of the health care providers can be associated with one or more different health care facilities. For example, the health care providers can be associated with a hospital 302, a private practice 303 (e.g., doctor's office), and/or a rehabilitation facility 304. The patient's health care team also includes members of the patient's household 305 (e.g., family members, close friends, or caregivers). The members of the health care team can change as the patient's condition and health care needs evolve. New team members can be added, and existing team members can be removed over time. Methods describing health care team formation are provided in U.S. application Ser. No. 13/966,265, filed on Aug. 13, 2013, which is incorporated by reference in its entirety.

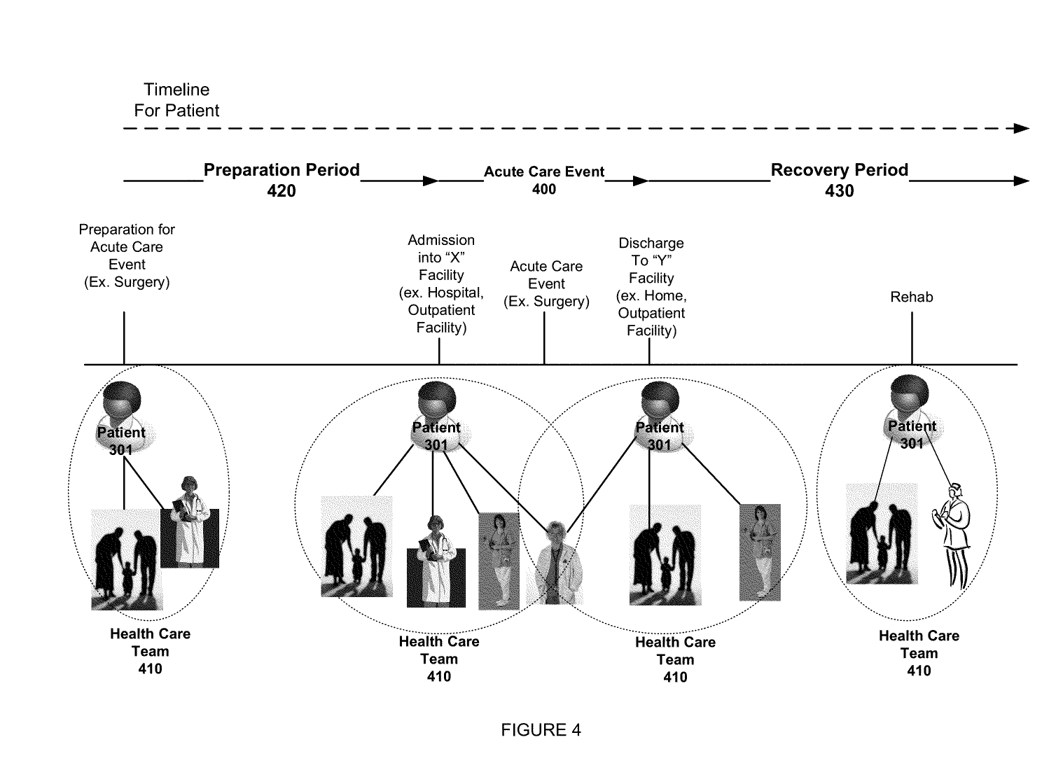

FIG. 4 shows an example of a timeline of an acute care event 400 for a patient. The timeline shows periods of time prior to (preparation period 420), during, and after an acute care event 400 (recovery period 430). Prior to the acute care event 400, the patient 301 may take measures and actions to prepare for the acute care event 400. During this period, the patient's health care team 410 can include a patient's family members and members of a health care team 410, such as a primary care doctor. The patient 301 is then admitted into a facility for the acute care event 400, for example, to undergo surgery. As shown in FIG. 4, when the patient 301 is admitted to Facility “X,” such as a hospital, the health care team 410 can change its roles to include more or less health care providers, such as a physician, a charge nurse, and a case manager, and/or to change the individuals filling the various roles on the health care team 410.

After the surgery, the patient 301 can be discharged from the facility to another facility (e.g., home, outpatient, rehab) and assigned one or more health care tasks and guidelines for post event care. These health care tasks and guidelines (e.g., action items) can be presented on an interactive checklist on a mobile application, as described herein. At that time, the health care team 410 can include the patient's family members, a physician, and a home care nurse. Later on, the patient 301 may visit a rehabilitation facility, for example, and the health care team 410 can include the patient's family members and a physical therapist.

The roles that form a health care team and the members who fill the roles on the health care team can be determined by predetermined rules for generating a health care team (e.g., based on roles required for care of the patient during the preparation period, acute care event, or recovery period). For example, surgery may require a certain number of different roles to be filled on the health care team (e.g., surgeon, surgery nurse, anesthesiologist, etc.). As the patient's needs change and/or an acute care event takes place, different rules are used to determine which roles and health care providers are assigned to the patient and form the health care team. The changes in the structure and function of the health care team over time are made seamlessly, as the patient undergoes the acute care event, transitions moves from one facility to the next, or experiences changes in his or her medical condition.

Prior to an acute care event, a patient may be required to prepare for an acute care event by completing a number of tasks or health related activities. These pre-acute care event tasks or activities can include, for example, fasting, following a particular diet, exercising, resting, refraining from smoking or drinking alcohol, taking medications or supplements, or visiting a care facility or provider. Other pre-acute care event tasks can include, but are not limited to, getting x-rays, taking blood or stool tests, maintaining sodium levels, maintaining weight, avoiding solid foods (liquid diet), or avoiding strenuous activities.

After the acute care event takes place, the patient can also be required to perform post-event activities or tasks or to periodically report his progress or condition to the health care team. For instance, the patient may need to tend to surgical wounds (e.g., changing bandages or applying ointments), take medication on a timely basis, visit a follow-up health care provider or facility, or manage his or her diet and exercise. The pre- and post-acute care event tasks can also include reporting of the patient's health condition and various health barometers (e.g., ability to move or walk, fatigue levels, pain levels, digestive issues, symptoms, etc.).

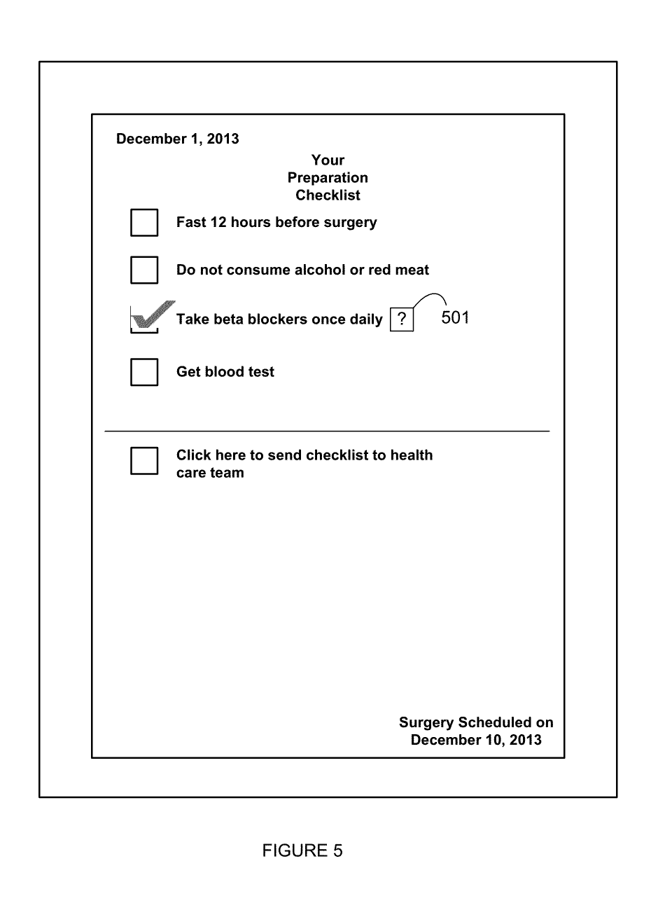

FIG. 5 provides an example of a screenshot of a user interface for the checklist application 125 and messaging module 126 on a user device, according to one embodiment of the invention. A user interface can be provided to the user that displays a checklist of action items for the patient to complete prior to the acute care event. For example, the patient may be required to fast 12 hours before surgery or instructed to avoid consumption of alcohol or read meat prior to surgery. When a user checks an action item as completed on the checklist, an automatic notification can be sent to the system to indicate that the action item has been completed. The system can send notifications to members of the health care team to indicate that one or more action items have been completed by the patient.

On the other hand, if an action item on the checklist has not been completed by a certain date or period of time, the system is notified about the pending or delinquent action item. In some embodiments, the system can send a reminder notification to the patient to complete the action item. The system can also send notifications to the members of the health care team notifying the provider that the action item has not been completed. In response, one or more providers can communicate with the patient about the checklist items via the messaging module on the mobile application. The health care team members can also revise or reconfigure the checklist action items to include or remove various tasks, according to changes in the patient's condition or treatment decisions. These changes can be implemented in real-time and dynamically as the patient's communications are sent to members of the health care team.

In another embodiment, the system can provide an automatic notification and/or prompt to the patient about upcoming tasks to be completed. These notifications and/or prompts can be sent to the health care team members.

In other embodiments, notifications can be sent to the patient and/or health care team when the patient fails to complete a task or send a communication by a designated time or date. These notifications can be sent automatically when a deadline has passed for completion of a task. In other embodiments, the notification can be sent manually by one of the health care team members to the patient. The notification can be sent via text message, email, or phone message, or other phone, web, mobile, or computer-implemented method to the patient and health care team members.

In some embodiments, a patient can report to the health care team members about the patient's condition and/or completion of one or more checklist activities prior to and after the acute care event. For example, a patient may need to prepare for the acute care event by completing a health care task (e.g., by maintaining a liquid diet for two days) or reporting a health-related parameter (e.g., patient's pain levels) prior to being admitted to the health care facility.

The checklist can also be interactive, in some embodiments. As explained above, a mobile application executing on the patient's device can expose interfaces to the messaging module 126 such that the patient can select an item on the checklist and communicate with the healthcare team regarding that item. For example, if the patient has a question about the “Take beta blockers once daily” item on the checklist, the user can select this item or select an icon associated with this item (e.g., icon 501) to ask a question about this item. In one example, the selection opens a user interface or questions box on the checklist page that allows the patient to enter a question or comment. The question/comment can be transmitted to the healthcare team or to the designated member of the team along with the context associated with the question. For example, the healthcare team may be able to determine that the question was asked with regard to this particular checklist or with regard to the “Take beta blockers once daily” item on the checklist, making it easier for the healthcare team member to understand the context associated with the question and respond appropriately.

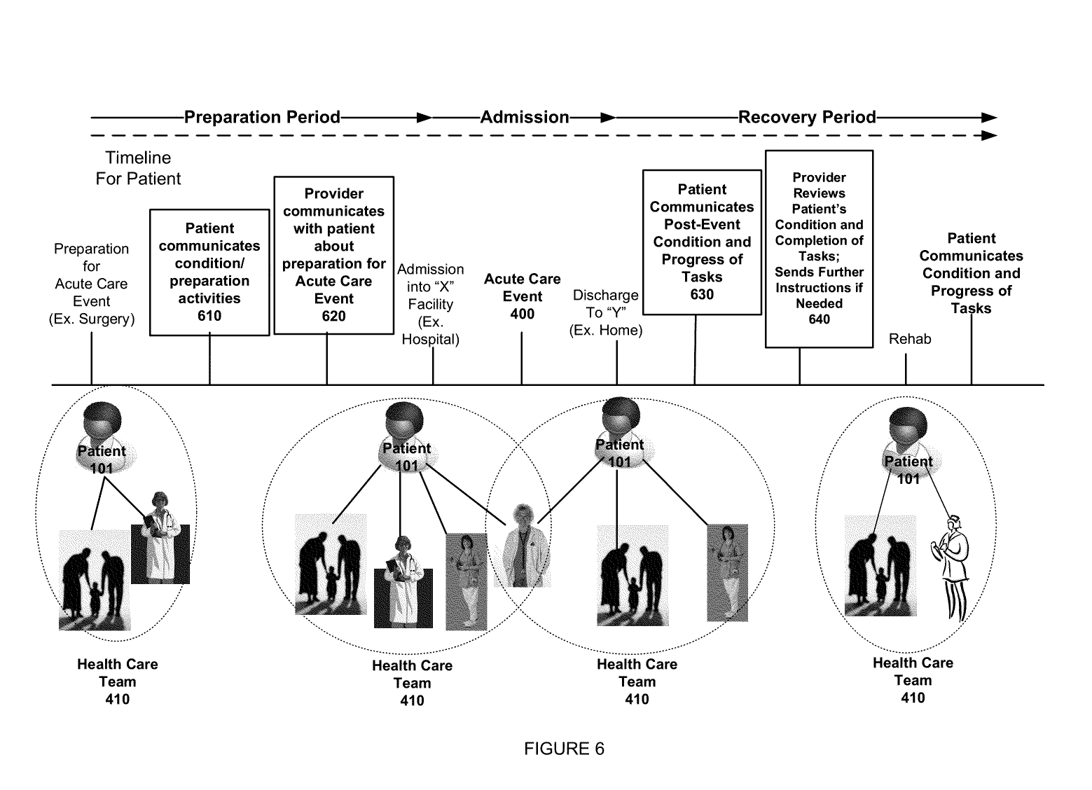

As shown in FIG. 6, the patient 301 can communicate or report 410 his condition and/or completion of the task to the health care team 410 of provider(s) prior to admission into the health care facility. In one example, if the patient 301 has failed to report completion of the task, a member of the health care team 410 can cancel or reschedule the acute care event 400. In another embodiment, a health care provider 410 can send 620 a communication to the patient about preparation for the acute care event 400, such as a reminder message to the patient to complete one or more action items prior to the acute care event 400. In some cases, the health care provider 410 can send a message to the patient's family members or caregivers to remind them about the health care task(s) to be completed. If the patient has completed all of the pre-acute care event requirements, then the patient can be admitted into the health care facility and the acute care event 400 can take place.

After the acute care event 400 takes place and the patient 301 has been discharged from the health care facility, the patient 301 can continue to engage and communicate 630 with the health care team members 410 about his or her condition and/or completion of post-event tasks via the mobile application. For example, a patient may need to report his ability to walk after completion of surgery or any discomfort or pain after a hospital visit. A provider can monitor the patient's condition and completion of post-acute care event tasks, and communicate 640 with the patient (e.g., with further instructions) based on the patient's communications with the health care team.

In some embodiments, the provider(s) on the health care team 410 can reconfigure the rules that determine the action items on the patient's checklist. The system can update the rules for determining the action items on the checklist and generate a new checklist of action items for the patient. In other embodiments, the provider can change and update the action items on the patient's checklist, and an updated checklist is sent to the patient's mobile application.

The changes to the action items on the checklist can be made in response to a patient's communications or notifications about his or her symptoms, changes in recovery, or reactions to medications, for example. The provider can intervene and reconfigure the patient's post-acute care event checklist (including tasks/activities, treatment, or prescription) based on the communications from the patient. The patient's communications with the health care team about his progress and/or condition can help the health care team members to intervene and make any needed course corrections regarding the patient's treatment. For example, if the patient is experiencing signs of infection after the hospital visit, a member of the health care team can instruct the patient to return to the hospital or to visit his primary care physician for a follow-up visit. In another example, if a patient is reporting an increase in pain after surgery, a health care team member can adjust the amount of pain medications prescribed to the patient.

In some embodiments, the patient can set his or her own health related goals to be met after the acute care event. These can include, for example, weight loss goals or health measurements (e.g., cholesterol levels, blood pressure). The patient can add these to the checklist and communicate his or her progress to the health care team.

In certain embodiments, methods are provided for the patient's family members and/or caregivers to communicate directly with the other health care providers. In some cases, the family members or care givers can communicate on the patient's behalf. For example, if a patient is recovering from surgery, a family member can send a communication to the health care team about the patient's condition or progress.

In some embodiments, methods are provided for the patient to communicate with the current health care team members assigned to the patient, as the providers change over time and as the patient is moved from one location to another. The system also provides for a user interface for the patient to view the identities of the health care providers assigned to his or her care. For example, the patient can view who is on the health care team while he is in the hospital (e.g., Nurse Jones, Dr. Smith). Methods for messaging among health care team members are described in U.S. application Ser. No. 13/966,265, filed on Aug. 13, 2013, which is incorporated by reference in its entirety.

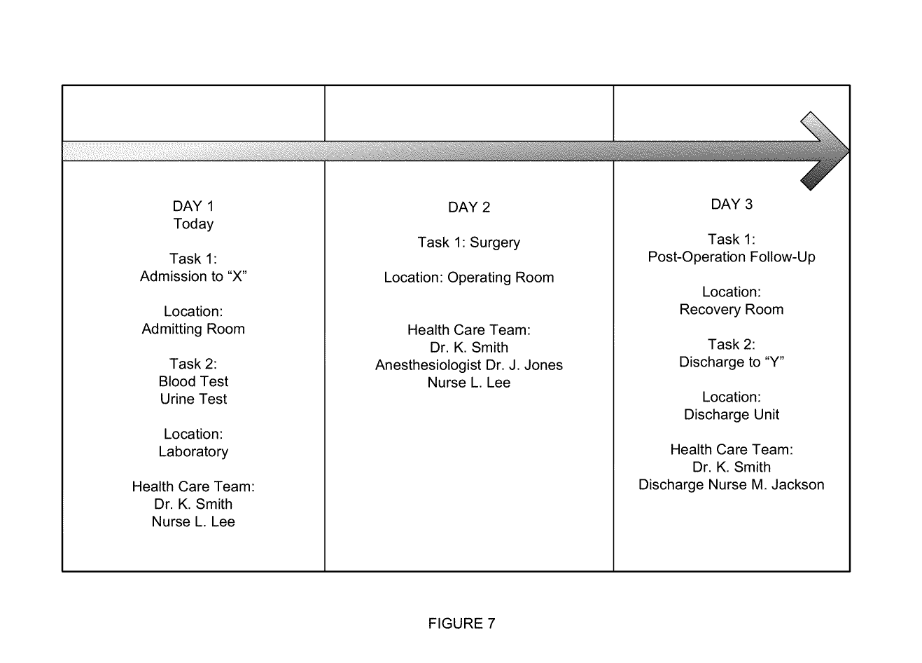

In other embodiments, methods are provided for the patient to view with the various tasks and activities related to the acute care event. In some embodiments, the user interface for the patient includes information about the locations of the facilities, roles and data about the health care personnel, instructions for preparation and/or recovery, and information about the acute care event. As shown in FIG. 7, a patient is admitted into a health care facility “X” and can view a display in the mobile application about the acute care event, according to an embodiment of the invention. Facility “X” can be a hospital, outpatient facility, clinic, etc. The user interface displays the health care tasks assigned to each day of the patient's stay. The display can also show the health care team members that are assigned to the patient for a particular day during the stay. For example, on Day 1, the treatment plan includes a blood test and a urine test. In some embodiments, the application also provides instructions to the patient about where to go in the facility to receive treatment (e.g., laboratory, operating room). Prompts or notifications can be sent to the patient (via mobile messaging or other form of online communication) to inform, assist, or direct the patient about the next tasks and locations on the patient's schedule. The patient can then be discharged to facility “Y,” which can be the patient's home, rehab facility, etc. This allows the patient to have an informative and guided experience in the health care facility and removes any confusion about the treatment plan (and locations) during the patient's stay.

Thus, the methods of the invention provide for the first time a simultaneous, dynamic process that allows for seamlessly changing the members of the health care team assigned to the patient according to the tasks or event or condition of the patient, providing direct engagement with the patient before, during, and after an acute care event, and providing interactive checklists for preparation and/or recovery periods of the patient. The methods of the invention allow for collaborative and dynamic patient care in a seamless manner in various patient transitions and health care settings.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for engaging with a patient, the method comprising:
accessing a plurality of rules configured for patient care before, during, and after an acute care event;
connecting a patient undergoing the acute care event to a plurality of providers on a health care team via a mobile application on a user device;
providing a user interface to the patient comprising an interactive checklist of action items for the patient to perform at a plurality of time points and comprising information about the acute care event, wherein the time points occur before, during, or after the acute care event, wherein the information about the acute care event comprises a location, members of the health care team, and a schedule of the acute care event;
providing an interface for communication among members of the health care team and for communication with the patient about the acute care event and the checklist of action items for the patient;
receiving an indication from the patient about whether the patient has completed one or more action items on the checklist; and
sending a notification to the members of the health care team about the one or more actions items that have been completed or are pending on the checklist.

2. The computer-implemented method of claim 1, further comprising configuring a plurality of rules for patient care before, during or after an acute care event.

3. The computer-implemented method of claim 1, further comprising responsive to receiving the indication from the patient, modifying one or more of the action items on the interactive checklist.

4. The computer-implemented method of claim 1, further comprising responsive to receiving the indication from the patient, modifying one or more of the rules associated with the acute care event.

5. The computer-implemented method of claim 1, further comprising receiving instructions from one or more members of the health care team to modify the action items on the checklist.

6. The computer-implemented method of claim 1, further comprising receiving instructions from one or more members of the health care team to modify the rules associated with the acute care event.

7. The computer-implemented method of claim 1, further comprising sending a notification to the patient to complete one or more action items before or after an acute care event.

8. The computer-implemented method of claim 1, wherein the interface for communication transmits a communication from the patient to a designated member of the healthcare team, and enables the designated member to respond directly to the patient or redirect the communication to another member of the healthcare team.

9. The computer-implemented method of claim 1, wherein the members on the health care team are determined based on roles required before, during and after the acute care event care of the patient.

10. The computer-implemented method of claim 1, wherein the interactive checklist of action items comprises action items associated with the patient's health.

11. The computer-implemented method of claim 1, wherein the interactive checklist of action items comprises inputs about the condition of the patient.

12. A computer-implemented method for engaging with a patient, the method comprising:
accessing a plurality of rules configured for patient preparation and care prior to an acute care event;
connecting a patient preparing to undergo the acute care event to a plurality of providers on a health care team via a mobile application on a user device;
providing an interactive checklist of action items to the patient based on the plurality of rules, the action items to be completed by the user prior to the acute care event;
receiving an indication from the user device about whether the patient has performed one or more of the action items on the interactive checklist prior to the acute care event;
sending a notification to the plurality of providers about the indication from the patient device about whether the patient has performed one or more of the action items on the interactive checklist prior to the acute care event;
responsive to receiving an indication from the patient that an action item has not been completed, sending a notification to the patient to complete the action item; and
providing an interface for the plurality of providers to communicate with the patient about the one or more action items to be completed.

13. The computer-implemented method of claim 12, further comprising configuring a plurality of rules for patient preparation and care prior to the acute care event.

14. The computer-implemented method of claim 12, further comprising responsive to receiving the indication from the patient, modifying one or more of the action items on the interactive checklist.

15. The computer-implemented method of claim 12, further comprising responsive to receiving the indication from the patient, modifying one or more of the rules associated with the acute care event.

16. The computer-implemented method of claim 12, further comprising responsive to receiving the indication from the patient, modifying or canceling the acute care event.

17. The computer-implemented method of claim 12, further comprising sending a notification to the plurality of providers that the patient has performed the one or more of the action items on the interactive checklist.

18. The computer-implemented method of claim 12, further comprising receiving instructions from one or more of the providers to reconfigure the plurality of rules based on the indication received from the patient.

19. The computer-implemented method of claim 18, further comprising providing a revised checklist of action items to the patient based on the instructions from the one or more health care providers.

20. The computer-implemented method of claim 12, further comprising providing a user interface for the patient and the plurality of providers to communicate directly about the interactive checklist of action items.

21. The computer-implemented method of claim 12, further comprising providing a user interface for the patient and the plurality of providers to communicate directly about the preparation of the patient prior to the acute care event.

22. The computer-implemented method of claim 12, further comprising receiving one or more additional action items from a provider on the health care team to add to the interactive check list.

23. The computer-implemented method of claim 12, wherein receiving an indication from the patient comprises receiving an indication that the user has checked off an action item on the interactive checklist.

24. The computer-implemented method of claim 12, wherein receiving an indication from the user comprises receiving an indication that the user has not checked off the action item on the interactive checklist.

25. The computer-implemented method of claim 12, further comprising sending an automatic notification to the patient about action items that need to be completed on the interactive checklist.

26. The computer-implemented method of claim 12, wherein the plurality of providers on the health care team are based on roles associated with pre-acute care event care of the patient.

27. The computer-implemented method of claim 12, wherein the interactive checklist of action items comprises action items associated with the patient's health.

28. The computer-implemented method of claim 12, wherein the interactive checklist of action items comprises inputs about the condition of the patient.

29. A computer-implemented method for engaging with a patient, the method comprising:
accessing a plurality of rules configured for patient preparation and care after an acute care event;
connecting a patient undergoing the acute care event to a plurality of providers on a health care team via a mobile application on a user device;
providing an interactive checklist of action items to the patient based on the plurality of rules, the action items to be completed by the user after the acute care event;
receiving an indication from the user device about whether the patient has performed one or more of the action items on the interactive checklist after the acute care event;
sending a notification to the plurality of providers about the indication from the patient device about whether the patient has performed one or more of the action items on the interactive checklist after the acute care event;
responsive to receiving an indication from the patient that an action item has not been completed, sending a notification to the patient to complete the action item; and
providing an interface for the plurality of providers to communicate with the patient about the one or more action items to be completed.

30. The computer-implemented method of claim 29, further comprising configuring a plurality of rules for patient preparation and care after an acute care event.

31. The computer-implemented method of claim 29, further comprising responsive to receiving an indication from the patient that an action item has not been completed, modifying the plurality of rules associated with patient preparation and care after an acute care event.

32. The computer-implemented method of claim 29, further comprising responsive to receiving an indication from the patient that an action item has not been completed, modifying one or more of the action items on the interactive checklist.

33. The computer-implemented method of claim 29, further comprising sending a notification to the plurality of providers that the user has performed one or more of the action items on the interactive checklist.

34. The computer-implemented method of claim 29, further comprising receiving instructions from one or more of the providers to reconfigure the plurality of rules based on the indication received from the patient.

35. The computer-implemented method of claim 33, further comprising providing a revised checklist of action items to the patient based on the instructions from the one or more health care providers.

36. The computer-implemented method of claim 29, further comprising providing a user interface for the patient and the plurality of providers to communicate directly about the post-acute care event treatment of the patient.

37. The computer-implemented method of claim 29, further comprising receiving one or more additional action items from a provider on the health care team to add to the interactive check list.

38. The computer-implemented method of claim 29, wherein receiving an indication from the patient comprises receiving an indication that the patient has checked off an action item on the interactive checklist.

39. The computer-implemented method of claim 29, wherein receiving an indication from the patient comprises receiving an indication that the patient has not checked off the action item on the interactive checklist.

40. The computer-implemented method of claim 29, further comprising sending an automatic notification to the patient about action items to be completed on the interactive checklist.

41. The computer-implemented method of claim 29, wherein the plurality of providers on the health care team are based on roles associated with post-acute care event care of the patient.
